(19) United States
(12) Patent Application Publication
(10) Pub. No.: US 2022/0227445 A1
(43) Pub. Date: Jul. 21, 2022

(54) POWERED UNICYCLE WITH IN-LINE SUPPORT PLATFORMS

(71) Applicant: Razor USA LLC, Cerritos, CA (US)

(72) Inventors: Terry Guo, Cerritos, CA (US); Jerry Tao, Cerritos, CA (US)

(21) Appl. No.: 17/563,922

(22) Filed: Dec. 28, 2021

(30) Foreign Application Priority Data
Dec. 29, 2020 (CN) 202023250274.6

(51) Int. Cl. B62K 1/00; B62K 11/00

(52) U.S. Cl. CPC B62K 1/00; B62K 11/007

(57) ABSTRACT

Powered unicycles are disclosed. In some embodiments, the powered unicycle can be self-balancing, and can include a forward foot support located in front of the wheel of the unicycle in the direction of travel of the wheel, and a rearward foot support located behind the wheel of the unicycle. The powered unicycle can include at least one sensor configured to sense a change in position or orientation of the powered unicycle due to a shift in weight of a user standing or sitting on the unicycle, and control the operation of a hub-mounted drive motor to move the powered unicycle based on the sensed change in position or orientation of the powered unicycle.

### CROSS REFERENCE

This application claims priority under at least 35 U.S.C. § 119(a) of Chinese Utility Model Patent Application No. 2020232502746, filed Dec. 29, 2020, the entirety of which is incorporated by reference herein.

### BACKGROUND

### Field

The present disclosure relates to powered vehicles, such as a powered unicycle having in-line support platforms aligned with a direction of travel.

### Description of Certain Related Art

With increasing awareness of the environmental impact of vehicles, travelers are increasingly interested in more environmentally friendly methods of travel. Electric vehicles, and in particular personal electric vehicles, provide an environmentally friendly and convenient vehicle option. Such personal electric vehicles can be used for short-range travel, and can be usable in locations where larger personal vehicles, including automobiles, motorcycles, and bicycles, can be more difficult to operate.

An example personal electric vehicle is a two-wheeled electric balance scooter having a side-by-side wheel arrangement, such as a co-axial wheel arrangement in which one wheel is to one side of a user supported by one or more platforms and the other wheel is on the opposite side of the user. The two-wheeled electric balance scooter can include a battery or other power source, with the wheels driven by one or more motors, such as a brushless motor, and controlled by a scooter controller, which can be a single-chip microprocessor. An attitude sensor detects angular velocity and tilt angles to coordinate and control the balance of the electric balance scooter body. By shifting the center of gravity of the user, the electric balance scooter can be controlled, and can be commanded to start, accelerate, decelerate, and stop, among other control commands. The side-by-side arrangement of embodiments of such electric balance scooters increases the width of the vehicle, which can cause the vehicle to be less convenient to carry and store.

### SUMMARY OF CERTAIN FEATURES

The systems, methods and devices described herein have innovative aspects, no single one of which is indispensable or solely responsible for their desirable attributes. Without limiting the scope of the claims, some of the advantageous features will now be summarized.

In one broad aspect, a powered unicycle is provided, including a wheel having a rotational axis, a motor configured to drive the wheel to drive the wheel along a direction of travel of the wheel generally perpendicular to the rotational axis of the wheel, a control system configured to control the application of power from the motor to the wheel, a first support platform offset from the wheel in a first direction along the direction of travel of the wheel, and a second support platform offset from the wheel in a second direction along the direction of travel of the wheel, the second direction opposite the first direction.

The powered unicycle can further include a supplemental support structure located above the wheel. The supplemental support structure can include a telescoping bar assembly configured to adjust the height of the supplemental support structure. The supplemental support structure can include a balance saddle supported at an upper end of the supplemental support structure.

The powered unicycle can include at least one sensor in communication with the control system, the at least one sensor configured to provide a sensor signal indicative of at least one of movement or orientation of the powered unicycle. The at least one sensor can include a gyroscope. The at least one sensor can include an accelerometer. The control system can be configured to generate a control signal based at least on part on the provided sensor signal using a proportional-integral-derivative control system.

The control system can be configured to command application of power from the motor to the wheel based on a roll angle between the powered unicycle and the vertical. The control system can be configured to control the application of power from the motor to the wheel to balance the powered unicycle.

In another broad aspect, a self-balancing powered unicycle is provided, including a wheel having an axle, a hub mounted motor configured to drive the wheel, a controller in communication with the hub mounted motor, the controller configured to control the operation of the hub-mounted motor, a first foot support offset from the wheel in a first direction perpendicular to the axis of the wheel, and a second foot support offset from the wheel in a second direction perpendicular to the axis of the wheel, the second direction opposite the first direction.

The powered unicycle can include a body, the first and second foot supports extending outward from opposite sides of the body. The powered unicycle can additionally include a support saddle structure having an adjustable height, and the support saddle structure can extend upward from the body. The first and second foot supports can extend upward and outward from the opposite sides of the body.

The powered unicycle can include an accelerometer and a gyroscope in communication with the controller. The controller can be configured to determine a change in orientation of the powered unicycle based upon sensor signals received from the accelerometer and the gyroscope. The controller can be configured to control the operation of the hub-mounted motor based at least in part on a determined change in orientation of the powered unicycle.

In another broad aspect, a method of controlling a self-balancing powered unicycle is provided, the method implemented by a control system of the powered unicycle, the method including receiving at least one sensor signal indicative of a shift in weight of a user having a first foot supported by a first platform located forward of a wheel of the powered unicycle and a second foot supported by a second platform located rearward of a wheel of the powered unicycle, generating a control signal based at least in part on the received sensor signal, and commanding the operation of a hub mounted motor to drive the wheel of the powered unicycle based at least in part on the shift in weight of the user.

Receiving the at least one sensor signal can include receiving at least one of an accelerometer signal and a gyroscope signal. Generating a control signal based at least in part on the received sensor signal can include using a proportional-integral-derivative control system to generate a pulse width modulated control signal.

Generating a control signal based at least in part on the received sensor signal can include determining a tilt angle of the powered unicycle relative to the vertical due to the shift in weight of the user. Commanding the operation of a hub mounted motor to drive the wheel of the powered unicycle can include commanding the operation of a hub mounted motor to drive the wheel of the powered unicycle at a speed dependent on the determined tilt angle.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a side view of an embodiment of a self-balancing powered unicycle having in-line supporting platforms for supporting the feet of a user.

FIG. 2 is a front view of the self-balancing powered unicycle of FIG. 1.

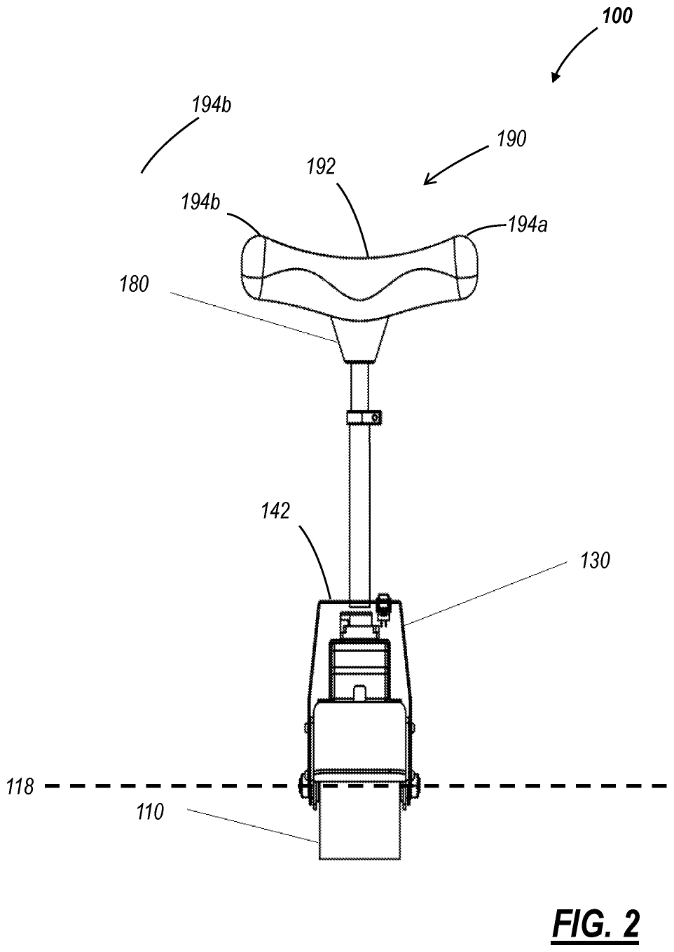

FIG. 3 is an exploded perspective view of the self-balancing powered unicycle of FIG. 1.

FIG. 4 is a side view of the self-balancing powered unicycle of FIG. 1, shown with the legs of a user standing on the support platforms.

FIG. 5 is a side view of the self-balancing powered unicycle of FIG. 1, shown in a forward canted position at an angle to the vertical.

FIG. 6 is a flowchart illustrating a method for controlling the operation of a self-balancing powered unicycle.

### DETAILED DESCRIPTION OF CERTAIN EMBODIMENTS

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

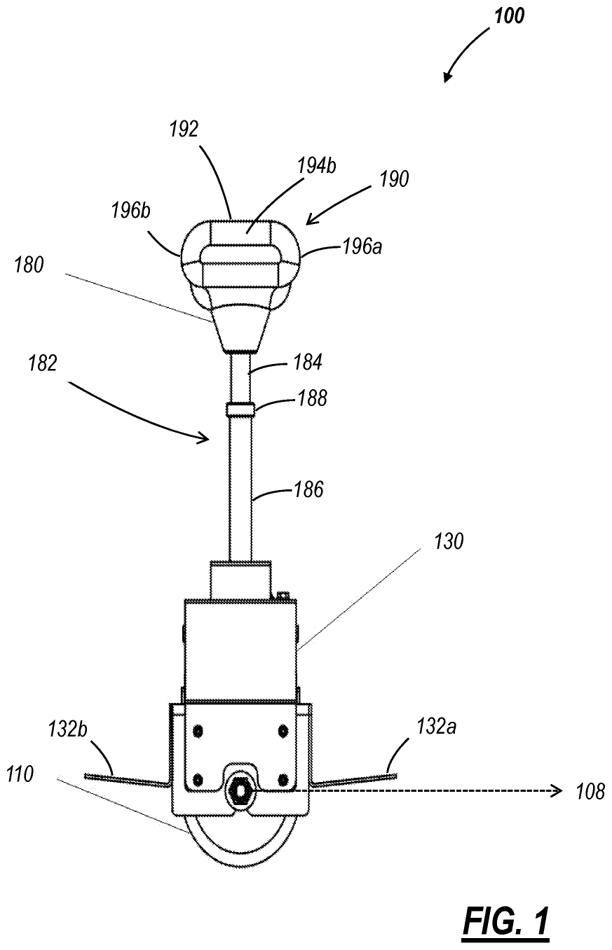

FIG. 1 illustrates a vehicle, such as a powered unicycle 100, having a powered, central wheel 110, a body 130 and a supplemental support structure 180 extending upwardly from the body 130. In the illustrated embodiment, the supplemental support structure extends upwardly from the center of the body 130. The wheel 110 is configured to rotate around an axis of rotation 118 to drive the powered unicycle along a direction of travel 108. The direction of the arrow 108 can be called the front direction and the opposite direction can be called the rear direction. The axis comprising the front direction and the rear direction can be called the front-rear direction.

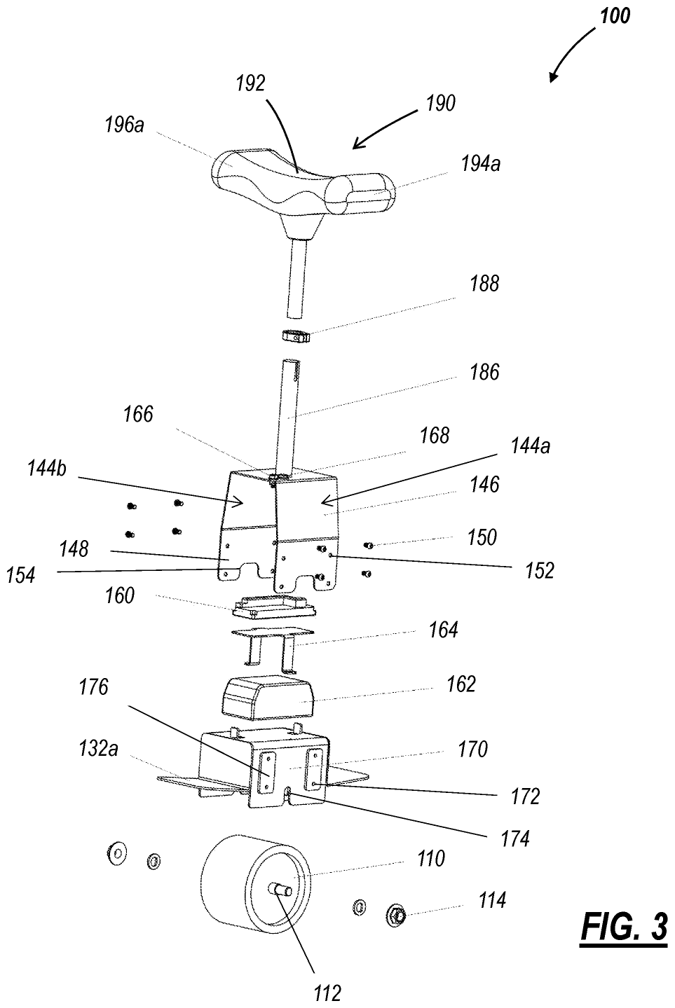

The powered unicycle 100 includes a pair of support platforms 132a and 132b extending respectively from the front and rear of the body 130. As can be seen in FIG. 3, the support platforms 132a and 132b in the illustrated embodiment are generally rectangular in shape, and have rounded outer corners. As can be seen in FIG. 1, the support platforms 132a and 132b are not coplanar with one another and/or are canted slightly (e.g., upwards and inward). The outer edges of the platforms away from the body 130 can be located at a height slightly higher than the interior edges adjacent the body 130.

In some embodiments, the plane of the support platform 132a and the plane of the support platform 132b can intersect at a line which is generally coaxial with a rotational axis 118 of the wheel 110. However, in other embodiments, the support platforms 132a and 132b can be oriented in different positions relative to the wheel 110, so that the planes of the support platform 132a and of the support platform 132b intersect at a line located above or below the rotational axis 118 of the wheel 110.

In some embodiments, the support platforms 132a and 132b can include surface features or textures, such as grip tape, which can inhibit or prevent the feet of a user from slipping off of the support platforms 132a and 132b during operation of the powered unicycle 100.

In the illustrated embodiment, the support platforms 132a and 132b are fixed relative to the remainder of the body 130. In some embodiments, the support platforms 132a and 132b can be integral with another portion of the body, such as by bending a section of sheet metal outward to form a platform at a desired angle. In other embodiments, the support platforms 132a and 132b can be secured, such as through welding, adhesive, fasteners, or any other suitable securement means to the remainder of the body 130.

In some embodiments, at least a portion of an entirety of each of the platforms 132a and 132b can be foldable or pivotable relative to the body 130. For example, a pivot assembly such as a hinge can be provided that is configured to allow a portion or an entirety of the platforms 132a and 132b to fold or pivot relative to the body 130. In some implementations, the platforms 132a and 132b can be movable between a retracted position in which they are positioned adjacent, and/or in contact with, or within the body 130 and a deployed position in which they extend outward from the body 130 and are oriented at a desired angle to the body 130. In some embodiments, the pivot assembly can be located a distance away from the body 130, so that a portion of the platforms 132a and 132b can be folded outward in a deployed position to increase the size of the platforms 132a and 132b.

The supplemental support structure 180 can include a telescoping bar assembly 182 including at least an upper bar section 184 coaxial with and linearly translatable with respect to a lower bar section 186. The upper bar section 184 has an outer diameter which is smaller than an inner diameter of the lower bar section 186, such that at least a portion of the upper bar section 184 is received within the lower bar section 186. A clamp ring 188 at or near the top of the lower bar section 186 can be adjusted between at least a first configuration in which the clamp ring 188 does not constrain translation of the upper bar section 184 relative to the lower bar section 186, and a second configuration in which the clamp ring 188 constrains translation of the upper bar section 184 relative to the lower bar section 186. This constraint can occur, for example, through a frictional fit with the upper bar section 184. In some embodiments, other constraining mechanisms can be used, such as a biased pin which can extend through a plurality of apertures in one of the sections of the telescoping bar assembly 182.

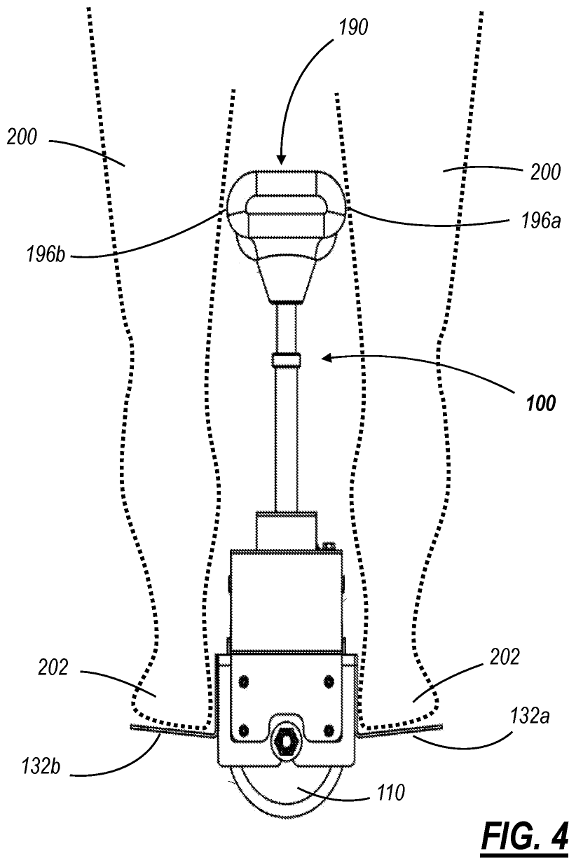

The supplemental support structure 180 can include a balance saddle 190 supported at the top of the telescoping bar assembly 182. The balance saddle 190 can have an ergonomic profile configured to allow for comfortable contact with various portions of a user's body during operation. In the illustrated embodiment, the balance saddle 190 is wider in a lateral direction parallel to the rotational axis 118 of the wheel 110 than it is in a longitudinal direction parallel to the direction of travel 108. The upper surface 192 of the balance saddle 190 has a concave profile between raised and rounded side edges 194a and 194b. The portion of the balance saddle 190 extending between the side edges 194a and 194b can have a generally constant cross-sectional profile along a curved axis. The leading side edge 196a and trailing side edge 196b can be rounded. In certain embodiments, the balance saddle 190 comprises a seat on which a user sits. In some embodiments, a user squeezes, grasps, or pinches the balance saddle 190 between their legs (see FIG. 4).

In some embodiments, the balance saddle 190 can be cushioned for comfort and/or to reduce the likelihood of injury to a user. In some embodiments, the balance saddle 190 can have a soft exterior layer over at least a portion of the balance saddle 190, and can have a cushioning layer beneath the exterior layer, such as a memory foam material or other cushioning material. The cushioning material can extend at least underneath the upper surface 192 of the balance saddle 190, and can in some embodiments also extend underneath the leading side edge 196a and trailing side edge 196b.

By adjusting the relative positioning of the upper bar section 184 and the lower bar section 186 of the telescoping bar assembly 182, the height of the supplemental support structure 180, and of the balance saddle 190, can be adjusted to accommodate riders of differing heights and riding styles.

In various embodiments of powered unicycles, a wide variety of designs and structural and functional components can be used to form the body 130. The particular embodiment illustrated in FIG. 3 is non-limiting, and is provided as one of many possible embodiments.

The body 130 can include an upper housing bracket 140 having a central horizontal section 142 to which the base of the lower bar section 186 of the telescoping bar assembly 182 is attached. Extending downward from the lateral edges of the central horizontal section 142 are generally vertical side sections 144a and 144b. In the illustrated embodiment, the generally vertical side sections 144a and 144b include an upper angled section 146 and a lower vertical section 148.

In the illustrated embodiment, the front and rear portions of the upper housing bracket 140 are open. In some variants, the upper housing bracket 140 can include one or more panels extending between the generally vertical side sections 144a and 144b to close at least a portion of the area therebetween.

A controller 160 can be disposed within the body 130, such as under the central horizontal section 142 of the upper housing bracket 140. The controller 160 may include a processing element such as a microprocessor, as well as one or more sensors operably connected to the processing element. The sensors of the powered unicycle 100 can be used, for example, to sense tilting of the powered unicycle 100 caused by the user, and can also be used to sense the direction of applied force and the angular acceleration of the powered unicycle 100. For example, the controller 160 can be operably connected to a gyroscope which can be used to detect movement of the human body, and the controller 160 can in turn adjust the operation of the powered unicycle 100 in response. The powered unicycle 100 can also include an accelerometer in addition to a gyroscope. Other suitable sensors and combinations thereof can be used in other embodiments to detect movement of the powered unicycle 100 and/or the user. In some implementations, the powered unicycle 100 includes one or more sensors, such as pressure sensors, in the platforms 132a and 132b. Signals from the pressure sensors can be sent controller 160, which can adjust the operation of the powered unicycle 100 in response. For example, more pressure on one platform than another platform can result in the powered unicycle 100 being driven in the direction of the platform with more pressure.

In some embodiments, the powered unicycle 100 can include an MPU-6050 module, manufactured by TDK InvenSense, which includes a MEMS 3-axis gyroscope and 3-axis accelerometer. The MPU-6050 module can gather sensor data and provide the sensor data to a processor of the controller 160 for use in controlling the powered unicycle 100.

The body 130 can include a power source 162, such as a battery. An internal bracket 164 can overlie the power source 162 and can support the controller 160. The internal bracket 164 can allow one or both of the power source 162 and the controller 160 to be securely retained in place. A power switch 166 operably coupled to the controller 160 and the power source 162 is supported by the body 130 at a location accessible to a user. In the illustrated embodiment, the power switch 166 is mounted in the central horizontal section 142 of the upper housing bracket 140, although the power switch 166 can be located at any other suitable location on the body 130 or elsewhere on the powered unicycle 100.

The body 130 can include a charging port 168 or other connector which can be used to charge the internal power source 162. In the illustrated embodiment, the charging port 168 is mounted in the central horizontal section 142 of the upper housing bracket 140, next to the power switch 166, although the charging port 168 can be located at any other suitable location on the body 130 or elsewhere on the powered unicycle 100 in other embodiments.

The power source 162 can be supported by a lower housing bracket 170 dimensioned to fit over the wheel 110, enclosing the upper portion of the wheel 110. In the illustrated embodiment, the support platforms 132a and 132b extend from the front and rear sides, respectively, of the lower housing bracket 170. In some embodiments, the lower housing bracket 170 can be formed by manipulating (e.g., cutting and bending) a single sheet of metal to form the lower housing bracket 170 and the support platforms 132a and 132b, although in other embodiments, some portions of the lower housing bracket 170 and/or the support platforms 132a and 132b can be formed separately.

The lower edges of the side walls of the lower housing bracket 170 comprise apertures 174 dimensioned to allow an axle 112 of the wheel 110 to extend therethrough, so that the lower edges of the side walls of the lower housing bracket 170 can be located below the axle 112, as can be seen in FIG. 1. In some embodiments, the apertures 174 can be defined by notches in the lower housing bracket 170 and a structure extending across the notch at a point below the upper edge of the notch. The lower edges of the lower vertical sections 148 of the generally vertical side sections 144a and 144b of the upper housing bracket 140 include notches 154 which are sufficiently wide to allow the axle 112 of the wheel 110 to extend therethrough. In the illustrated embodiment, the notches 154 are wider than the apertures 174, so that the notches 154 provide clearance for the retaining nuts 114 used to secure the axle 112 relative to the lower housing bracket 170.

The upper housing bracket 140 can be secured to the lower housing bracket 170 by a plurality of fasteners 150, such as rivets. The fasteners 150 can extend through a plurality of apertures 152 in the upper housing bracket 140 and a corresponding plurality of apertures 172 in the lower housing bracket 170. The lower housing bracket 170 can include one or more reinforcing structures 176, such as reinforcing plates, located adjacent the apertures 172 in the lower housing bracket 170.

The fasteners 150 can rigidly couple the upper housing bracket 140 to the lower housing bracket 140. This arrangement can retain the controller 160 and power source 140 in the space between the two housing brackets. The supplemental support structure 180 can be rigidly attached to the upper housing bracket 140. The axle 112 of the wheel 110 can extend through the apertures 174 in the lower housing bracket 170, and can be retained in place in part by the retaining nuts 114. The telescoping bar assembly 182 can be used as a handle, allowing the powered unicycle 110 to be carried by a user when not being ridden.

In some embodiments, the wheel 110 can be driven by a hub motor, not explicitly illustrated in the figures. In other embodiments, other suitable drive mechanisms, such as friction drive, chain drive, or other drive mechanisms, can be utilized to drive the wheel 110.

In some embodiments, a user can ride the powered unicycle in an upright standing position. FIG. 4 illustrates the powered unicycle 100 with the legs 200 of a user shown. The user can stand with one foot 202 on each of the support platforms 132a and 132b, straddling the balance saddle 190. In an upright standing position, the user can brace a portion of their legs against one or both of the leading side edge 196a and trailing side edge 196b of the balance saddle 190 to stabilize themselves while standing on the powered unicycle 200, as well as to affect the roll angle of the powered unicycle 100.

In other embodiments of unicycles, the feet of a user can be located on opposite sides of the wheel, offset from the wheel along the rotational axis of the wheel. In contrast, the support platforms 132a and 132b of powered unicycle 100 are offset from front and rear sides of the wheel 110 along the direction of travel 108 of the powered unicycle 100. The stance of a user riding the powered unicycle 100 can be similar to the stance of a user riding a skateboard, with the feet of the user oriented generally perpendicular to the direction of travel 108 of the powered unicycle 100. Neither the support platforms 132a and 132b nor any portion of the legs 200 of the user intersect the axis of rotation 118 of the wheel 110 during operation of the powered unicycle 100.

The point on the legs 200 of the user at which the leading side edge 196a and trailing side edge 196b make contact can depend upon both the position in which the supplemental support structure 180 is secured as well as the relative height of the user. In some embodiments, the calves and/or knees of the legs 200 of the user can make contact with the balance saddle 190, while in other embodiments and/or configurations, a user can contact the balance saddle 190 with other portions of their legs 200.

Operation of the powered unicycle 100 while in an upright standing position can be easier for less experienced riders. However, more experienced riders can choose to sit on the balance saddle 190 with their feet on the support platforms 132a and 132b, rather than straddling and standing over the balance saddle 190. In the illustrated embodiment, the balance saddle 190 is configured for use either as a seat or as a leg bracing structure, and is symmetrical from side to side to allow the user to ride with either their left leg or their right leg on the forward support platform. In some embodiments, such as where the powered unicycle 100 will be ridden primarily by a particular skilled user, the balance saddle 190 can be detachable, and can be replaced with a balance saddle or seat more suited for seating, such as an asymmetrical seat designed to be sat on in a single orientation.

During operation, the controller 160 can receive signals from sensors such as a gyroscope and/or an accelerometer, indicative of the motion and orientation of the powered unicycle 100. In some embodiments, the received signals can be pulse-width modulated signals, but in other embodiments, other types of signals can be received. An acceleration signal received from the accelerometer can be integrated to obtain information regarding the displacement of the powered unicycle. The gyroscope and accelerometer signals can be used in conjunction with a proportional-integral-derivative (PID) control system to obtain a pulse width modulated control signal. The duty cycle can be output to control the driving motor, in order to control the driving and orientation of the powered unicycle 100, adjusting this control in real time in response to real-time sensor signals.

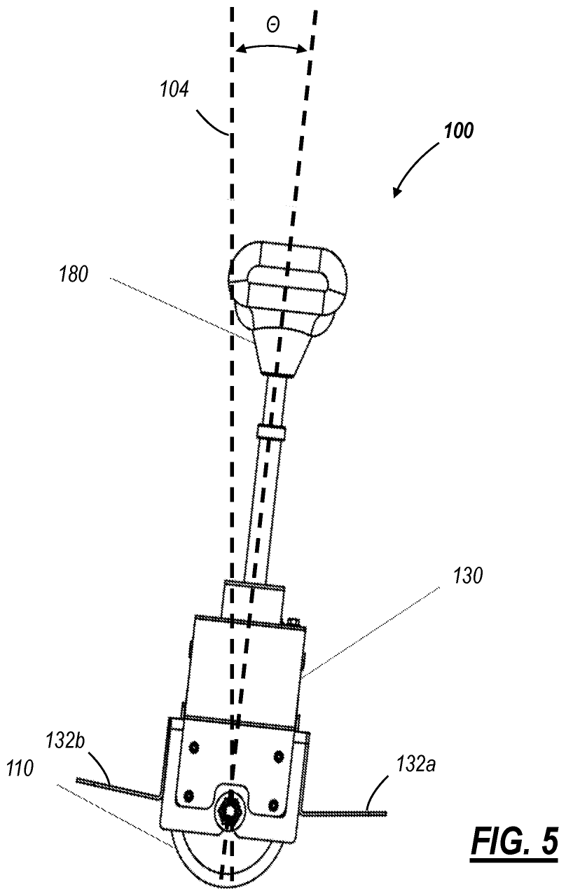

FIG. 5 is a side view of the powered unicycle of FIG. 1, in a forward-tilted position. The powered unicycle 100 has been pitched forward about the axis of rotation 118 of the wheel 110 by a roll angle Θ relative to the vertical 104. It can be seen in FIG. 5 that, due to the upward cant of the leading support platform 132a, the forward support platform 132a has only moved to a horizontal position, rather than being canted downward. This upward cant of the support platforms 132a and 132b can inhibit or prevent a rider's foot from sliding off one of support platforms 132a and 132b when the powered unicycle 100 is pitched forward or backward about the axis of rotation 118 of the wheel 110.

The controller can determine the orientation of the powered unicycle 100, and control the motor based at least in part on the determined orientation. For example, if the powered unicycle 100 is canted forward, the motor can be driven to move the powered unicycle 100 in the direction in which the powered unicycle 100 is pitched. The speed and/or acceleration of the powered unicycle 100 can be based at least in part on the magnitude of the roll angle Θ. Similarly, if the powered unicycle 100 is canted backwards, the motor can be driven to slow and/or reverse the powered unicycle 100, with the speed and/or deceleration of the powered unicycle 100 based at least in part on the magnitude of the roll angle Θ.

In addition to shifting their weight forward or backward to control the operation of the motor and the resulting forward and/or backward motion in the direction of travel 108, a user can also steer the powered unicycle 100 by shifting their weight side to side to cause a corresponding shift in the direction of travel. In some embodiments, the user can control the powered unicycle 100 by leaning in the front direction or the rear direction. The powered unicycle 100 (e.g., the sensors and controller) can detect such leaning and control the motor accordingly.

Despite these shifts in the weight of the user, and resulting changes in the orientation of the powered unicycle 100, controller 160 of the powered unicycle 100 can control the motor of the unicycle to balance the powered unicycle 100 during operation, thereby inhibiting or preventing the powered unicycle 100 from tipping over. In some embodiments, the controller 160 can balance in the front-rear direction (the direction parallel to the direction of travel 108), while relying on the user to maintain balance in the side-to-side direction (the direction parallel to the axis 118), along with stabilizing gyroscopic forces when the powered unicycle is in motion.

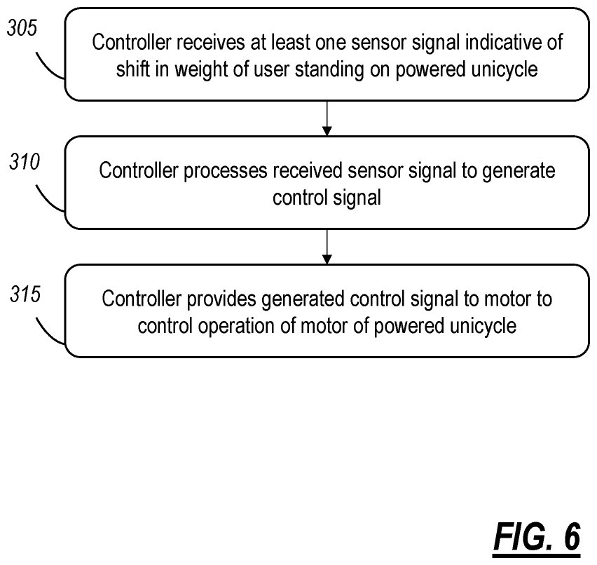

FIG. 6 is a flow chart illustrating a process 300 for controlling the operation of a powered unicycle. At block 305, a controller of a powered unicycle receives at least one signal from at least one sensor, the at least one signal indicative of a shift in weight of a user standing on the powered unicycle. Prior to receipt of the at least one sensor signal, the controller of the powered unicycle can actively control the operation of a motor of the powered unicycle to balance the unicycle.

In some embodiments, the at least one signal can include a gyroscope signal from a gyroscope of the powered unicycle. In some embodiments, the at least one signal can include an accelerometer signal from an accelerometer of the powered unicycle. In some embodiments, the at least one sensor signal can include a gyroscope signal and an accelerometer signal. The at least one sensor signal can be indicative of angular movement of the powered unicycle which changes the orientation of the powered unicycle with respect to the vertical, such as tilting the powered unicycle forward or backward about the wheel of the unicycle, resulting in a non-zero roll angle relative to the vertical.

At block 310, the controller processes the received at least one sensor signal to generate a control signal. In some embodiments, the controller of the powered unicycle can utilize a PID control process to generate the control signal. In some embodiments, the controller of the powered unicycle can process the accelerometer signal by integrating the accelerometer signal to provide an indication of the displacement of the powered unicycle, such as the angular displacement about the wheel axis of the powered unicycle. In some embodiments, the controller of the powered unicycle can process the sensor signal or signals to determine a roll angle by which the powered unicycle is canted forward or backwards in a plane defined by the direction of travel of the powered unicycle and the vertical. In some embodiments, the generation of a control signal can include obtaining a pulse-width modulated signal based at least in part on the at least one received sensor signal.

At block 315, the controller provides the generated control signal to the motor to control the operation of the motor of the powered unicycle. The providing of the generated control signal can, for example, include outputting of the duty cycle. The controller can, through providing of the generated control signal, command the rotation of the motor in a forward or rearward direction to control movement and/or acceleration of the powered unicycle in the direction of travel. In addition to commanding movement of the powered unicycle in the direction of travel, the controller can also control the operation of the motor to balance the powered unicycle to inhibit or prevent the powered unicycle from tipping forward or backward.

Although described herein as multiple distinct steps, the reception of the received sensor signal or signals, along with the generation and use of the control signal, can be done in real-time in a constant iterative process during operation of the powered unicycle.

Although certain embodiments of powered unicycles are described herein, embodiments of powered unicycles implementing the disclosed technology may also include other features not specifically described herein. For example, in some embodiments, the powered unicycle can include a pressure sensor or other suitable sensor to detect the presence of a rider standing or seated on the powered unicycle, and use signals received from the pressure sensor in the control of the powered unicycle. Other sensors and/or control features can be used to provide a user with additional control over the operation of the powered unicycle, such as controls or other settings to limit a maximum speed of a powered unicycle, to control the sensitivity of the roll angle detection, or otherwise control the operation of the powered unicycle in any desired fashion.

In some embodiments, additional components may be provided to assist with the stability of the powered unicycles. For example, additional wheels, which may include removable training wheels, may be provided to further assist in maintaining the stability of the, particularly for novice riders. Such assistive wheels can be unpowered wheels, and can in some embodiments be removable once a rider achieves a sufficient degree of comfort. In some embodiments, the powered unicycle may include an upwardly extending handle or other component which can be gripped by one or both hands of the user to assist with stability. Like the supplemental wheels, such a stabilizing handle can in some embodiments be removable and/or collapsible. If such a stabilizing handle is laterally offset from the telescoping bar assembly 182, the stabilizing handle may be installable on either side of the telescoping bar assembly 182, or may be rotated around the telescoping bar assembly 182, to accommodate riders with different leading feet.

In some embodiments, cosmetic features may be provided which can alter the appearance of the powered unicycle. In addition to the use of a replaceable balance saddle as discussed above, additional features, such as cosmetic cladding or alternative housing components, may be used to alter the appearance of the powered unicycle. Such features may provide functionality in addition to altering the appearance of the powered unicycle. For example, one or more lights can be installed on the powered unicycle, which can serve as a safety feature in addition to providing a cosmetic affect on the appearance of the powered unicycle.

In the illustrated embodiments, the support pedals are offset from front and rear sides of the wheel along the direction of travel of the powered unicycle. In other embodiments, however, the disclosed technology can also be implemented in powered unicycles having laterally offset support platforms on either side of the powered wheel.

Many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Certain terminology may be used in the description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

Some embodiments have been described in connection with the accompanying drawings. The figures are drawn to scale, but such scale should not be interpreted as limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The features in the claims are to be interpreted broadly based on the language employed in the claims, and not limited to the examples described in the present specification or during the prosecution of the application, which examples are to be construed as non-exclusive. The examples described in the specification and drawings should be considered as illustrative only. A true scope and spirit of the disclosure is indicated by the claims and their full scope of equivalents.

The following is claimed:

1. A powered unicycle, comprising:
a wheel having a rotational axis,
a motor configured to drive the wheel to drive the wheel along a direction of travel of the wheel generally perpendicular to the rotational axis of the wheel;
a control system configured to control the application of power from the motor to the wheel;
a first support platform offset from the wheel in a first direction along the direction of travel of the wheel; and
a second support platform offset from the wheel in a second direction along the direction of travel of the wheel, the second direction opposite the first direction.

2. The powered unicycle of claim 1, further comprising a supplemental support structure located above the wheel.

3. The powered unicycle of claim 2, wherein the supplemental support structure comprises a telescoping bar assembly configured to adjust the height of the supplemental support structure.

4. The powered unicycle of claim 2, wherein the supplemental support structure comprises a balance saddle supported at an upper end of the supplemental support structure.

5. The powered unicycle of claim 1, wherein the powered unicycle comprises at least one sensor in communication with the control system, the at least one sensor configured to provide a sensor signal indicative of at least one of movement or orientation of the powered unicycle.

6. The powered unicycle of claim 5, wherein the at least one sensor comprises a gyroscope.

7. The powered unicycle of claim 5, wherein the at least one sensor comprises an accelerometer.

8. The powered unicycle of claim 5, wherein the control system is configured to generate a control signal based at least on part on the provided sensor signal using a proportional-integral-derivative control system.

9. The powered unicycle of claim 1, wherein the control system is configured to command application of power from the motor to the wheel based on a roll angle between the powered unicycle and the vertical.

10. The powered unicycle of claim 1, wherein the control system is configured to control the application of power from the motor to the wheel to balance the powered unicycle.

11. A self-balancing powered unicycle, comprising:
a wheel having an axle;
a hub mounted motor configured to drive the wheel;
a controller in communication with the hub mounted motor, the controller configured to control the operation of the hub-mounted motor;
a first foot support offset from the wheel in a first direction perpendicular to the axis of the wheel; and
a second foot support offset from the wheel in a second direction perpendicular to the axis of the wheel, the second direction opposite the first direction.

12. The powered unicycle of claim 11, wherein the powered unicycle comprises a body, the first and second foot supports extending outward from opposite sides of the body.

13. The powered unicycle of claim 12, additionally comprising a support saddle structure having an adjustable height, the support saddle structure extending upward from the body.

14. The powered unicycle of claim 12, wherein the first and second foot supports extend upward and outward from the opposite sides of the body.

15. The powered unicycle of claim 11, wherein the powered unicycle comprises an accelerometer and a gyroscope in communication with the controller, the controller configured to determine a change in orientation of the powered unicycle based upon sensor signals received from the accelerometer and the gyroscope, the controller configured to control the operation of the hub-mounted motor based at least in part on a determined change in orientation of the powered unicycle.

16. A method of controlling a self-balancing powered unicycle, the method implemented by a control system of the powered unicycle and comprising:
receiving at least one sensor signal indicative of a shift in weight of a user having a first foot supported by a first platform located forward of a wheel of the powered unicycle and a second foot supported by a second platform located rearward of a wheel of the powered unicycle;
generating a control signal based at least in part on the received sensor signal; and
commanding the operation of a hub mounted motor to drive the wheel of the powered unicycle based at least in part on the shift in weight of the user.

17. The method of claim 16, wherein receiving the at least one sensor signal comprises receiving at least one of an accelerometer signal and a gyroscope signal.

18. The method of claim 16, wherein generating a control signal based at least in part on the received sensor signal comprises determining a tilt angle of the powered unicycle relative to the vertical due to the shift in weight of the user.

19. The method of claim 18, wherein commanding the operation of a hub mounted motor to drive the wheel of the powered unicycle comprises commanding the operation of a hub mounted motor to drive the wheel of the powered unicycle at a speed dependent on the determined tilt angle.

20. The method of claim 16, wherein generating a control signal based at least in part on the received sensor signal comprises using a proportional-integral-derivative control system to generate a pulse width modulated control signal.
